(19) United States
(12) Patent Application Publication
(10) Pub. No.: US 2005/0015380 A1
(43) Pub. Date: Jan. 20, 2005

(54) Communication method and communication module

(76) Inventors: Rainer Burkhardt, Leonberg (DE); Andreas Heinzelmann, Klettgam (DE); Steffen Koser, Uhingen (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/486,701

(22) PCT Filed: Jun. 20, 2002
(86) PCT No.: PCT/EP02/06834

(30) Foreign Application Priority Data
Aug. 17, 2001 (DE) 101 40 519.7

(51) Int. Cl. G06F 17/00

(52) U.S. Cl. 707/100

(57) ABSTRACT

The document proposes a method for communication between a plurality of local applications and a diagnostic application in a motor vehicle, where data are transmitted from the local applications to the diagnostic application using a transmission medium, and a corresponding communication module having the steps of event-oriented provision of the data by the local applications, acceptance of the data by a communication module when initiated by the event-oriented provision of the data, management and conditioning of the data by the communication module, and transfer of the conditioned data from the communication module to the central application, with the conditioning of all the data accepted from the local applications, within the communication module, comprising data formatting into a data format which is determined by the central application. The method and the communication module are particularly suitable for performing an onboard system diagnosis in motor vehicles.

This application claims the priority of German patent document 101 40 519.7, filed 17 Aug. 2001 (PCT International Application PCT/EP02/06834, filed 20 Jun. 2002), the disclosure of which is expressly incorporated by reference herein.

### BACKGROUND AND SUMMARY OF THE INVENTION

The invention relates to a communication method and apparatus for distributing data in a motor vehicle in a defined, standardized manner, particularly for overall vehicle diagnosis, such as system diagnosis. The method is applied within a networked system which contains, for example, control units that are networked to a diagnostic unit for system diagnosis in the motor vehicle.

In a central application in a complex, networked system, communication and data interchange with subsystems is an important fundamental aspect which affects the diagnostic quality of the application functionality. A central application such as system diagnosis requires process data from individual control unit applications at the time of execution; and in the case of onboard diagnosis, these data must be provided continually, on an event-oriented basis.

As used herein, onboard diagnosis is understood to mean the vehicle's product-integrated self-diagnosis, independently of a service station. The diagnostic unit is thus located in the motor vehicle. To achieve a high-quality diagnostic result, precisely defined, standard provision of the data relevant to system diagnosis is required from the control units. The type of data provision thus has a substantial effect on the result of the system diagnosis.

German patent document DE 195 41 816 discloses a diagnostic system for a motor vehicle in which data formatting is performed in a communication module for all types of control units that are installed in the vehicle, and have different communication protocols. Thus, vehicle diagnosis can be performed independently of the control units' communication protocols. The system is used for diagnosis in the respective control units, with the communication module being used for communication between a control unit and the vehicle diagnosis. Because the data transmission is initiated by the vehicle diagnosis, the diagnostic system is not suitable for event-oriented vehicle diagnosis. Accordingly, it is not suitable for onboard diagnosis.

German patent document DE 44 43 218 discloses a device for storing diagnosis-related data in motor vehicles, including control units that are designed to be able to communicate with one another via a bus, and are configured to recognize errors independently and send requests for setting error codes to the data bus. A bus memory module capable of communicating with the control units is configured to store diagnostic data in response to such a request, so that the data can then be read for later evaluation. However, the system does not reformat data into a data format prescribed by the diagnostic module, and it is thus not possible to perform any data evaluation which is independent of control unit hardware. In addition, the data delivered by the control units are not selected according to diagnostic relevance. The resources of the data bus are therefore not used efficiently, and the system is therefore also not suitable for onboard diagnosis.

The diagnostic methods based on the prior art thus share the following restrictions:
The system diagnosis uses the offboard information associated with the individual control units, which is not sufficient for a future onboard diagnosis.
The different implementations of the communication and of the interfaces between control units and system diagnosis (e.g., with regard to error transmission, setting/resetting the status of errors, designing the specifications) requires an interface in each diagnostic modules, that is individually matched to the associated control unit.
The transmission capacity of the transmission protocol underlying the network interconnection is utilized inefficiently as a result of the transmission of data which are unimportant to the diagnosis.
Because the data transfer from the control units is initiated by the diagnostic process, so that the control units do not transfer their data until requested to do so, processing of the error setting conditions and the time reference are different.

One object of the present invention is to provide a communication module, and an operating method, which avoid the drawbacks of the prior art.

Another object of the invention is to provide standardized communication between local applications (such as control unit applications in control units) and a central application (particularly for system diagnosis), in order to facilitate onboard diagnosis.

Hereinafter, the central application is referred to as a system diagnosis application, and the local applications are referred to as control unit applications, without restricting the general nature. The local applications can also be any desired application which is able to provide diagnostic data (e.g., external temperature). The network interconnection of the system, and the transmission protocol used for data transmission in the system, are also referred to as a transmission medium below. The local applications are processes which operate within the hardware of, for example, control units. The central application is a process which preferably operates in the hardware of a diagnostic unit.

The system diagnostic data (also called process data) are transferred from the control unit application to the communication module on an event-oriented basis, when the value of the data changes. These data are managed and conditioned internally, by reformatting the data (which are available in the data format of the control unit applications' transfer interface) into a format that is prescribed by the diagnostic application, and is independent of the control unit application transfer data formats. Preferably in a defined cycle, the process data are converted into the respective transmission format and are transmitted to the system diagnosis application using a standard transmission protocol. The method can have its parameters adjusted to suit the requirements of the target hardware, using a configuration process. The internal data management, the transmission format and the transmission protocol are stipulated during this configuration phase on the basis of the magnitude of the system diagnosis-related process data.

In the method according to the invention, the control unit applications provide data for acceptance by the communication module according to the invention, on an event-oriented basis. (That is, the data are provided when a predetermined event occurs.) The data transfer is thus initiated by the respective control units, which transfer the appropriate data to the communication module when it is established that such an event has occurred. The database relating to whether an event results in data transfer is held in the control unit applications. Such events may be of external or internal type. Which events result in data transfer is specified by the system development process. (External events may be, for example, the occurrence of error states, such as failure of a brake light or a particular coolant temperature reaching of a threshold value, while internal events are, for example, computation errors which occur in a control unit itself.) The data are then immediately accepted by the communication module in the data format set by the control unit application interface. The communication module manages and conditions the data, preferably in two ways:
All data are reformatted from the data format of the control unit application interface into a specified data format that is known by the system diagnosis application and is independent of the local applications. (Hereinafter, such reformatting is referred to as data formatting in order to distinguish it from the coding described below.)
The data are coded onto a transmission protocol which forms the basis of the data transmission on the network interconnection between the control units and the diagnostic unit (e.g., a CAN bus or MOST).

In a preferred embodiment, data compression is also performed, using any known data compression method. During data formatting, the data formatted in accordance with the control unit application interfaces are preferably selected based on a relevance which is prescribed for an envisaged central application (e.g., system diagnosis relevance). Data which are not relevant to this application and are provided by the local applications are not processed further for the data formatting.

The relevant data are then rewritten in accordance with the format of the central application's interface, so that they are in a bit format which is known to the system diagnosis application. The diagnosis application therefore does not have to know the interface formatting of the individual control unit applications. This information is held in the communication module.

The communication module reorganizes the data provided by the control units according to the data format determined by the diagnosis application. Thus, data are available to the diagnosis application in a structure which is independent of the control unit application interfaces. This allows error-free interpretation of process data by the diagnosis application, without the need to modify the diagnosis application in the event of a change of control unit interfaces (e.g., if a faulty control unit is replaced by another control unit version or if a control unit application is updated).

The data conditioned in this manner are formatted in line with the underlying data transmission protocol in order to send them via the network interconnection between control units and diagnostic unit. In one preferred embodiment of the inventive method, a local preliminary diagnosis is also performed. To this end, diagnostic data which complement the data accepted on an event-oriented basis from the local applications are also generated specifically by initiating diagnostic routines in the individual control unit applications.

Management of the data in the communication module preferably comprises buffering between the receipt of data by the communication module and data transfer to the central application. Such buffering allows a transition from event-oriented data acceptance from the control unit applications by the communication module to coordination of the timing of data transfer for the conditioned data to the central application. Preferably, the data transfer from the communication module to the central application is initiated by the communication module (e.g., is controlled by the communication module). In this case, the timing of this data transfer can be determined by a timer in the communication module or by the transmission medium. The timer is preferably provided by a local application.

The data transfer from the communication module to the central application is preferably performed in a fixed transfer cycle triggered (i.e., set and initiated) by a timer (i.e., a time cycle transmitter in a local application). In this case, the data are preferably transferred only in the event of a data change relative to the preceding transfer cycle. This technique minimizes the computation power requirement and efficiently uses the transmission medium that networks the control units to the diagnostic unit.

In another embodiment of the invention, the data are buffer-stored in the communication module. This embodiment is used preferably when the volume of data accepted from the control unit applications exceeds the transmission capacity of the transmission protocol such that it is not possible to transfer all the data accepted from the local application between the communication module and the central application within one transmission cycle.

Examples of the system diagnosis of relevant process data are:
error states (e.g., no error, error, or no statement possible;
input and output states (e.g., active, inactive); and
internal states (e.g., switched, not switched analog values, such as measured values for state variables for vehicle components monitored by a control unit).

The communication module can handle all data types in a flexible manner. The system diagnosis-related process data must be transferred to the communication module immediately after a change in the values when data are provided on an event-oriented basis.

The data interchange between a central application, such as the system diagnosis in a motor vehicle, and local applications which are involved (e.g., control unit applications) is performed efficiently, in standard fashion and independently of the volume of data which are to be interchanged. This likewise applies to the management, conditioning and coding of the data which are to be sent by the individual local applications.

In one particular embodiment of the invention, distributed overall vehicle diagnosis is made possible. In this case, the flow of diagnostic routines, particularly error location routines, in the control unit applications is initiated under the control of the communication module. The diagnostic data ascertained directly in the control unit as a result are then transmitted from the communication module to the central application. To this end, the communication module may include, in addition to data conditioning means in the communication module (which are set up to format the data accepted from the local applications into a data format which is determined by the diagnostic application, and is independent of the local applications and/or to select the diagnosis-related data and/or to compress the data), means for controlling the local applications. Alternatively, the control unit applications may access the data in the communication module.

Parameters of the communication module can be set in optimum fashion for the respective target hardware during a configuration phase. In this context, the volume of data to be processed is used to determine the functionality of the internal data management, data conditioning and data coding. A plurality of available data coding mechanisms guarantee a high density of information within the network protocol on which the application is based (e.g., the CAN protocol). Specific embodiments of the invention allow intelligent variant handling.

The communication module's configuration phase is carried out prior to use of the communication method according to the invention. Configuration of the method proceeds from known data formats for the control unit applications, and the stipulated selection of which of the control unit data are relevant to diagnosis. During this configuration phase, the following adjustments to the communication module to suit the hardware and software (that is, control units, control unit applications and physical network interconnection and also network protocol of the networked system in which the inventive method is used) are preferably made:
The transmission format for transmitting data from the local applications to the central application is adjusted to suit the transmission format on which the network interconnection is based. As the selection for the transmission format, it is possible to select between the data protocol MOST or CAN, for example.
The types of control units which are in the network are recorded, and used to determine the location of the diagnosis-related data within the data format used by the control unit application in the control unit, for the data selection during the use of the method.
For the intelligent variant handling, the software and/or hardware version of the control unit application or of the control units is established. Based on this information, the location of the diagnosis-related data within the data format used by the control unit application is determined for the data selection during the use of the method. A further form of intelligent variant handling makes it possible to take into account different configurations for the control units within the vehicle. The diagnostic relevance of the data from a control unit application in a control unit may depend, for example, on whether the control unit is used in a vehicle with left or right-hand drive.

With the system prerequisites established in this way, it is possible to establish in the actual configuration phase whether the method is applied with buffer-storage of the data.

The inventive method affords the following advantages, in particular:
A standard interface is provided between the local applications and a central application.
The communication module is freely configurable for different local applications.
Intelligent variant handling is made possible.
The communication module is freely configurable for different transmission protocols (e.g., CAN, LIN, MOST).
A plurality of methods are provided for internal data management and data coding.
It is possible to integrate distributed diagnostic algorithms.
High information density for data transmission is assured.
The method works independently of the kind (type and volume) of data.
Intelligent selection of data which are relevant to the diagnosis and which are provided by the control unit applications minimizes the burden on the transmission system.
The flexibility of the communication module minimizes the complexity of integrating new control units into the networked system and allows the use of existing control units for onboard diagnosis.

Other objects, advantages and novel features of the present invention will become apparent from the following detailed description of the invention when considered in conjunction with the accompanying drawings.

### BRIEF DESCRIPTION OF THE DRAWINGS

FIG. 1 shows the basic design of a communication module according to the invention;

FIG. 2 shows an embodiment of the communication module and its preferred location in a networked system;

FIG. 3 illustrates the process steps of the method, according to the invention;

FIG. 4 illustrates the cyclic triggering of the data transfer from the communication module to the central application with an external timer; and

FIG. 5 shows the basic flow of the configuration phase in the method according to the invention.

### DETAILED DESCRIPTION OF THE DRAWINGS

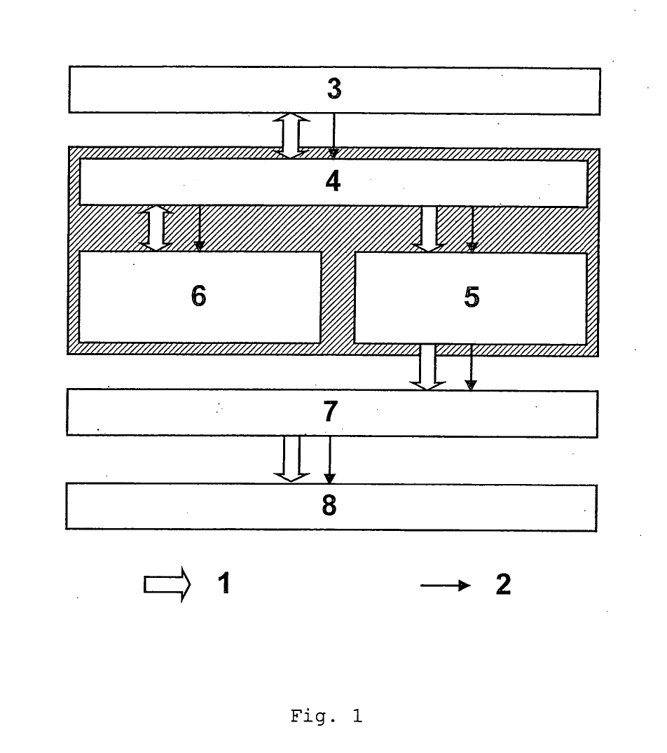

FIG. 1 shows the design of a communication module according to the invention, including the flow of data 1 and the flow of control 2 in the direction indicated by the arrow. A control unit application 3 transfers data to the communication module on an event-oriented basis, meaning that the initiation of data acceptance (and hence the flow of control) comes from the control unit application. In the particular embodiments for distributed diagnosis and/or when making data from the communication module available to the control unit applications, the flow of data can also run from the communication module to the control unit application.

Within the communication module, a flow controller 4 first checks to assure that the volume of data does not exceed the network protocol's capacity (in a single transmission cycle) for direct transmission, (via a transmission module 5), to the communication module's data transfer interface 7 and the diagnostic application 8 in the diagnostic unit. If the volume of data exceeds the transmission capacity, the data are forwarded to the data management module 6 for buffer-storage, under the control of the flow controller, and transmission of the data distributed over a plurality of transmission cycles. Data conditioning can be performed either in the data management module 6 or in the transmission module 5. The management and transmission modules 5,6 can also be combined in a single module; they are split in this case merely for the purposes of better illustration. If buffer-storage takes place, then the data conditioning is performed in the data management module 6.

If the transmission capacity of a transmission cycle is sufficient to transmit all of the data, then data conditioning takes place in the transmission module. The transmission module 5 sends the conditioned data to the diagnostic module data transfer interface 7 in the communication module. This data transmission is performed under the control of the transmission module 5 in the communication module. The elements of the communication module which are situated within the hatched area in the figure preferably operate within the control units.

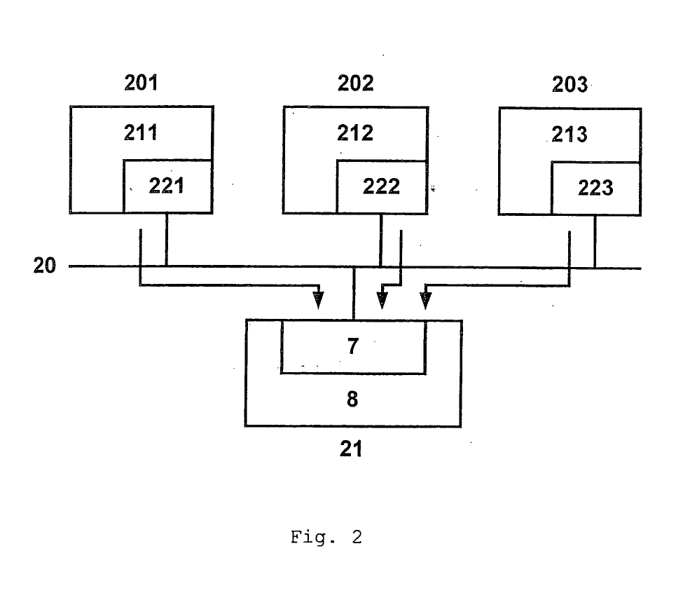

FIG. 2 shows the preferred allocation of the submodules of the communication module over the hardware in the networked system, using the example of a diagnostic system in a motor vehicle. The figure shows three control units 201, 202, 203, which are connected to a diagnostic unit 21 by means of a CAN bus 20. The flow of data via the CAN bus is illustrated by means of arrows. A respective control unit application 211, 212, 213 and a respective submodule 221, 222, 223 of the communication module operate within the control units. The submodules contain the data acceptance means and data conditioning means of the communication module and also means for sending the conditioned data from the submodule in the local applications to the data transfer interface. The conditioned data are transmitted via the CAN bus to the data transfer interface 7, which operates together with the diagnostic application 8 in a diagnostic unit 21.

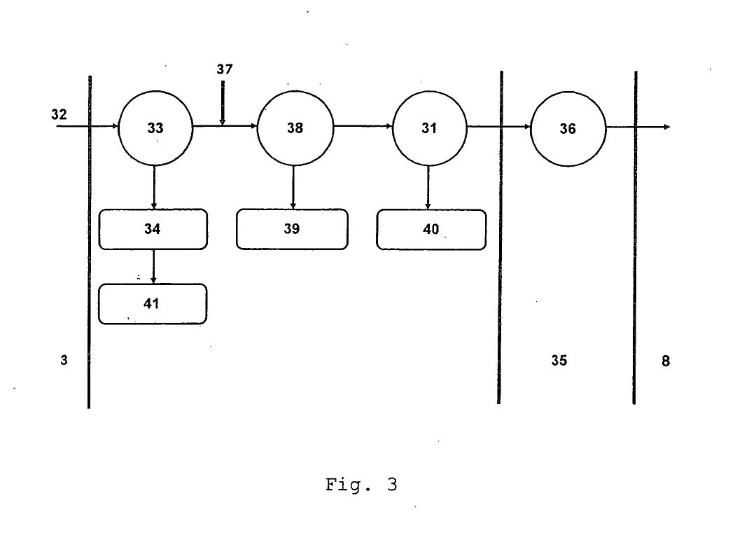

FIG. 3 is a flow diagram for the method according to the invention, up to transmission of the conditioned data via a data bus to the data transfer interface in the communication module. The vertical lines symbolize component boundaries. The process data 32 accepted from a control unit application 3 on an event-oriented basis are first of all managed 33. Depending on the data volume thereof, the data may be buffer-stored in a separate auxiliary memory 34. (Buffer-storage is performed if the volume of data exceeds the transmission capacity of one transmission cycle of the transmission medium 35 (e.g., of a CAN bus). If the data are buffer-stored, additional information can be ascertained 41. A timer 37 initiates further data processing by the communication module. The data are then conditioned 38, and a local preliminary diagnosis 39 may be performed. The conditioned data are then coded 31 in accordance with the transmission protocol of the transmission medium (e., a “CAN frame” 40 is created). Next, the data are sent and are transmitted using the transmission medium 35 (e.g., the CAN bus) to the data transfer interface in the communication module and are transferred to the diagnostic application 8.

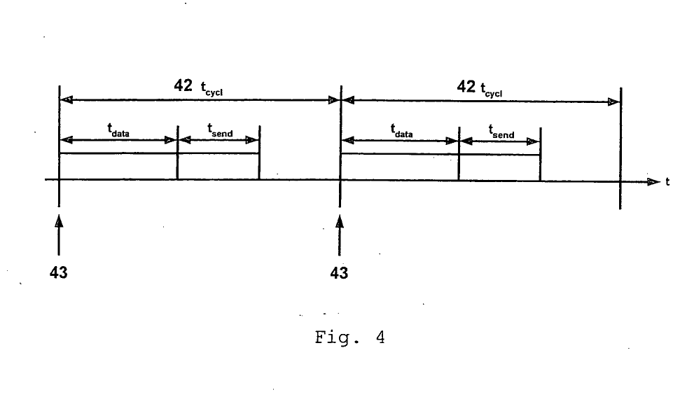

FIG. 4 shows the cyclic triggering of the data transfer from the communication module to the central application with an external timer, which is preferably provided by a local application. Two data transfer cycles 42 are illustrated, each started by means of timer triggering 43. Within each cycle time t_{cycl}, data provision (conditioning the data) is performed first in the time t_{data}. The send operation then takes place using the transmission medium in the time t_{send}.

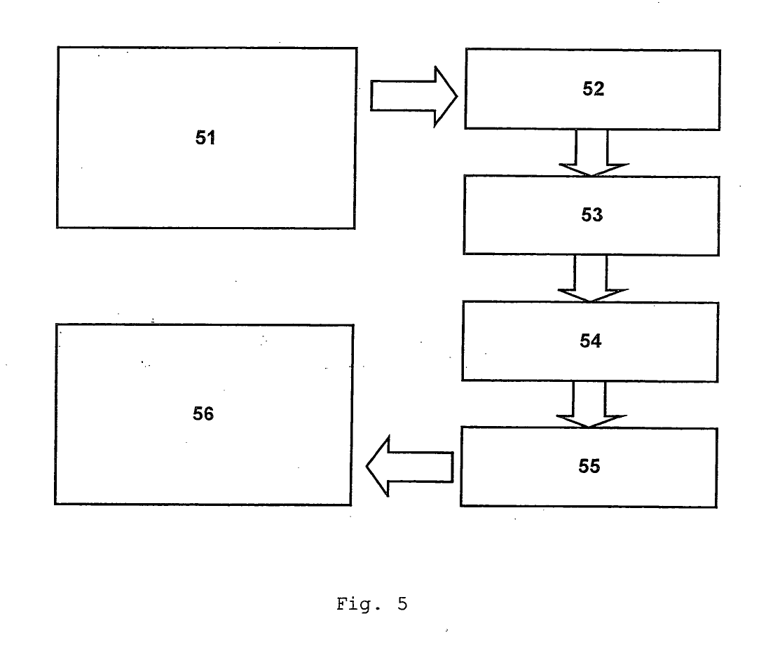

FIG. 5 shows the basic flow of the configuration phase in the inventive method. The input data 51 describing the system hardware and system software are first read in 52. These data comprise details about the control units, the control unit software, the hardware of the network interconnection and/or the transmission protocol which is to be used (e.g., a CAN protocol). In addition, they may also contain data relating to the configuration of the control units and/or data relating to the unit version and/or the control unit software version. For each control unit application interface to the communication module (established by the control unit software), characteristics such as data type, for example, are indicated for each process data item present in the interface. During read-in, a consistency check can be performed. Depending on the transmission protocol, the transmission format 53 is then stipulated. At this point, it is actually possible to stipulate whether a separate data store is needed in the communication module. Next, in a parameterization phase 54, the data for selecting and reformatting the interface data from the individual local applications are generated. Finally, the configuration data generated upon stipulation of the transmission format and in the parameterization phase are output 55, for example in files. These output data are used to configure the communication module. The output data comprise, for example, enable information for the algorithms required (e.g., regarding the use of a buffer store, information regarding the opportunities for access to data in the communication module by the control unit applications, all the process data information in the control unit applications and/or further information for data management, data conditioning and data transmission).

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-14. (Cancelled)

15. A method for communication of data between local applications and a diagnostic application in a motor vehicle, via a transmission medium, said method comprising:
event-oriented provision of data by the local applications;
acceptance of said data by a communication module when initiated by the event-oriented provision of said data;
management and conditioning of the data by the communication module; and
transfer of the conditioned data from the communication module to the diagnostic application; wherein
conditioning of data accepted from the local applications, within the communication module, comprises data formatting into a data format which is determined by the diagnostic application and is independent of the local applications.

16. A method for communication of data between local applications and a diagnostic application in a motor vehicle, via a transmission medium, said method comprising:
aligning a communication module with the local applications in a configuration phase;
the local applications, providing data on an event oriented basis;
the communication module accepting data when initiated by the event-oriented provision of the data;
the communication module managing and conditioning the data; and
transferring the conditioned data from the communication module to the diagnostic application; wherein
the conditioning of data accepted from the local applications, within the communication module, comprises data formatting into a data format which is determined by the diagnostic application and is independent of the local applications.

17. The method as claimed in claim 16, wherein said alignment comprises stipulation of data management and data conditioning algorithms in the communication module based on the type of the local applications, the type of hardware on which the local applications operate, the versions of the local applications, the version of the hardware on which the local applications operate and/or the configuration of the hardware, to suit a transmission protocol between the local applications and the diagnostic application.

18. The method as claimed in claim 15, wherein at least one of the following is true:
the local applications are control unit applications in control units in the motor vehicle; and
the method is used for onboard diagnosis.

19. The method as claimed in claim 18, wherein data conditioning comprises a local preliminary diagnosis in at least one control unit.

20. The method as claimed in claim 15, wherein at least one of the following is true:
management of the data comprises buffer-storage of the data;
data conditioning comprises compression; and
data conditioning involves selection of the data.

21. The method as claimed in claim 15, wherein the transfer of the conditioned data from the communication module to the diagnostic application is controlled by the communication module.

22. The method as claimed in claim 15, wherein the data are managed by the communication module such that one of the following is true:
data transfer to the diagnostic application can take place in a fixed cycle;
data transfer to the diagnostic application takes place only for data in the communication module which have changed with respect to the past cycle.

23. The method as claimed in claim 22, wherein a cycle for data transfer to the diagnostic application is triggered by the local applications.

24. The method as claimed in claim 15, wherein the data comprise one of error state data, input/output state data, internal state data from the local applications, and analog values.

25. A communication module in a motor vehicle for performing the method as claimed in claim 1, said module comprising:
data acceptance means for event-oriented acceptance of data from local applications;
data conditioning means for managing and conditioning the data; and
at least one data transfer interface to a diagnostic application; wherein
the data conditioning means format the data accepted from the local applications into a data format which is determined by the diagnostic application and is independent of the local applications.

26. A networked diagnostic system in a motor vehicle for performing the method as claimed in claim 18, said system comprising:
control unit applications as local applications;
a system diagnosis application as a central application; and
a communication module comprising data acceptance means for event-oriented acceptance of data from the control unit applications, data conditioning means for managing and conditioning the data and at least one data transfer interface to the system diagnosis application; wherein
the data conditioning means format the data accepted from the control unit applications into a data format which is determined by the system diagnosis application and is independent of the control unit applications.

27. The communication module as claimed in claim 25, wherein at least one of the following is true:
the communication module includes means for providing data for the local applications; and
the communication module has means for controlling the local applications.

28. The diagnostic system as claimed in claim 26, wherein at least one of the following is true:
the communication module includes means for providing data for the local applications; and
the communication module has means for controlling the local applications.

29. The diagnostic system as claimed in claim 26, wherein
control units are connected to a diagnostic unit by means of a network interconnection;
the data acceptance means for the event-oriented acceptance of data from the control unit applications and the data conditioning means for managing and conditioning the data are located in a submodule of the communication module in the control units;
the data transfer interface for transferring data to the system diagnosis application is located in the diagnostic unit; and
the submodule has means for sending data via the network interconnection to the data transfer interface in the diagnostic unit.
